(19) United States
(12) Patent Application Publication
(10) Pub. No.: US 2020/0230690 A1
(43) Pub. Date: Jul. 23, 2020

(54) Hydraulic Forging Machine And Method Of Replacing Upper Anvil Thereof

(71) Applicant: Zhongkejuxin Clean Energy & Hot Forging Equipment Research and Development Co. Ltd., Yancheng, Jiangsu (CN)

(72) Inventors: Lianhua ZHANG, Yancheng (CN); Hui ZHANG, Yancheng (CN); Haijun MA, Yancheng (CN); Baijin CHEN, Yancheng (CN); Yuanshi LI, Yancheng (CN)

(21) Appl. No.: 16/488,551

(22) PCT Filed: Sep. 19, 2017
(86) PCT No.: PCT/CN2017/102239

§ 371 Date: Aug. 23, 2019

(30) Foreign Application Priority Data
Feb. 23, 2017 (CN) 201710100139.7
Mar. 22, 2017 (CN) 201710174377.2

(51) Int. Cl. B21J 9/12; B21D 37/04; B21J 7/28; B21D 37/14; B21J 13/03; B21J 13/06; B21J 13/08; B30B 15/02; F16B 1/00; F16B 1/04

(52) U.S. Cl. CPC B21J 9/12; B21D 37/04; B21J 7/28; B21D 37/14; F16B 1/04; B21J 13/06; B21J 13/085; B30B 15/026; F16B 1/005; B21J 13/03

(57) ABSTRACT

A hydraulic forging machine and a method for replacing an upper anvil block thereof are disclosed. The hydraulic forging machine includes locking hydraulic cylinder that is fixed to a movable beam of the hydraulic forging machine when the hydraulic forging machine is in operation. The locking hydraulic cylinder is configured to provide a locking-unlocking function between an upper anvil block of the hydraulic forging machine and the movable beam. The locking hydraulic cylinder has its hydraulic power source supplied from a main hydraulic cylinder or a return hydraulic cylinder, which is also fixed to the movable beam. The present disclosure not only enables an oil supply circuit for the locking hydraulic cylinder to move together with the movable beam, but also simplifies the oil supply circuit for the locking hydraulic cylinder, resulting in an improved reliability of the hydraulic forging machine.

### CROSS-REFERENCE TO RELATED APPLICATION

This application is the U.S. national stage application of International Application No. PCT/CN2017/102239, filed on Sep. 19, 2017, which claims the priority benefit of China Patent Application No. 201710100139.7, filed on Feb. 23, 2017, as well as China Patent Application No. 201710174377.2, filed on Mar. 22, 2017. The above-identified patent applications are hereby incorporated by reference in their entirety.

### TECHNICAL FIELD

The present disclosure relates to the field of hydraulic drive technologies. More particularly, the present disclosure relates to a hydraulic forging machine provided with an improved locking hydraulic circuit for an upper anvil block, and a method of replacing the upper anvil block thereof.

### BACKGROUND

In order to quickly replace an upper anvil block of a hydraulic machine in a top-drive high-power hydraulic forging machine set, a quick replacement device is specially provided. The quick replacement device is fixedly mounted on a movable beam of the hydraulic machine so that the quick replacement device moves up and down together with the movable beam. The quick replacement device is structured as follows. A locking hydraulic cylinder is provided between the movable beam and the upper anvil block. The locking hydraulic cylinder is a one-way oil supply structure, which includes a rod-less chamber that has a reset spring therein. The cylinder body of the locking hydraulic cylinder is fixed to the movable beam. The locking hydraulic cylinder further includes a single piston rod that is, when extending and retracting, configured to move in and out of a locking hole of the upper anvil block, thereby quickly lock and unlock the upper anvil block. Specifically, when pressurized oil is supplied to the locking hydraulic cylinder, a fluid pressure acts against the reset spring in the hydraulic cylinder so that the piston rod retracts a locking pin out of the locking hole, and the upper anvil block is thereby detached. When the pressurized oil is discharged from the locking hydraulic cylinder, the reset spring acts upon the piston rod and pushes the piston rod to extend, which drives the locking pin to extend into the locking hole, and the upper anvil block is thereby locked.

A control valve is employed to control the pressurized oil for the locking hydraulic cylinder for the upper anvil block of the top-drive hydraulic forging machine. Specifically, the control valve guides the pressured oil coming out of a hydraulic pump to flow through a metal pipe to an upper location of the hydraulic forging machine. The pressurized oil subsequently flows through a hose to the locking hydraulic. The hose is fixed by a drag chain, and is capable of moving up and down together with the movable beam. Since the pressured oil is supplied to the locking hydraulic cylinder in the way described above, the connection has to be realized by a hose instead of a rigid conduit. The fatigue life and fatigue strength of the hose may result in cracks and oil leakage. Moreover, since the hydraulic forging machine involves thermal processing, thermal radiation from the thermal processing also adversely affects the life of the hose. In addition, having to make a connection between relatively moving parts not only increases the complexity of pipe connection, but also reduces the reliability of the locking hydraulic cylinder. Safety of production activities using the hydraulic machine is thus compromised.

It is thus desired for a simple and reliable hydraulic circuit that not only can achieve a locking function of an upper anvil block, but also does not include any connection part with relative movement.

### SUMMARY

This section is for the purpose of summarizing some aspects of the present disclosure and to briefly introduce some preferred embodiments. Simplifications or omissions in this section as well as in the abstract or the title of this description may be made to avoid obscuring the purpose of this section, the abstract and the title. Such simplifications or omissions are not intended to limit the scope of the present disclosure.

An object of the present disclosure is to provide a hydraulic forging machine and a method for replacing an upper anvil block thereof. An improved locking hydraulic circuit for the upper anvil block is provided, which not only achieves a locking function of the upper anvil block, but also allows synchronous movement of an oil supply circuit of a locking device for the upper anvil block and a movable beam, thereby simplifying the oil supply circuit for hydraulic locking, and also resulting in an improved reliability.

According to one aspect of the present disclosure, a hydraulic forging machine is provided. The hydraulic forging machine includes a movable beam, an upper anvil block being fixedly connected to the movable beam, a locking hydraulic cylinder being fixedly connected to the movable beam, a connecting pipe being fixedly connected to the movable beam, a control valve provided on the connecting pipe, and a hydraulic power source for the locking hydraulic cylinder, wherein the hydraulic power source is fixedly connected to the movable beam. Specifically, a first end of the connecting pipe is connected to the locking hydraulic cylinder, and a second end of the connecting pipe is connected to a pressurized oil chamber of the hydraulic power source. The hydraulic power source may include a main hydraulic cylinder or a return hydraulic cylinder. Moreover, the locking hydraulic cylinder is configured to provide a locking-unlocking function between the upper anvil block and the movable beam. The locking-unlocking function is realized by pressurized oil flowing between the locking hydraulic cylinder and the pressurized oil chamber of the hydraulic power source via the control valve and the connecting pipe.

In some embodiments, the hydraulic forging machine may further include the main hydraulic cylinder or the return hydraulic cylinder. One end of the main hydraulic cylinder may be connected to a fixed beam, whereas the other end of the main hydraulic cylinder may be fixedly connected to the movable beam.

In some embodiments, the locking hydraulic cylinder may be a single piston rod hydraulic cylinder. A reset spring may be provided in a rod-less chamber of the locking hydraulic cylinder, whereas an oil inlet-outlet may be provided within a rod chamber of the locking hydraulic cylinder. Moreover, the oil inlet-outlet may be connected to the first end of the connecting pipe. The upper anvil block is configured to be locked to the movable beam or unlocked from the movable bean by a telescoping motion of a piston rod of the locking hydraulic cylinder.

In order to lock the upper anvil block, the pressurized oil is to be discharged from the rod chamber of the locking hydraulic cylinder to the pressurized oil chamber of the hydraulic power source via the connecting pipe. The piston rod within the locking hydraulic cylinder may thus extend out due to a spring force provided by the reset spring to lock the upper anvil block. In order to unlock the upper anvil block, the pressurized oil is made to flow from the pressurized oil chamber of the hydraulic power source to the rod chamber of the locking hydraulic cylinder via the connecting pipe. A hydraulic pressure within the rod chamber of the locking hydraulic cylinder would thus impose a force against the reset spring to retract the piston rod within the locking hydraulic cylinder and unlock the upper anvil block.

Moreover, a cylinder body of the hydraulic power source is connected to the movable beam so that the cylinder body moves together with the movable beam. The second end of the connecting pipe is in communication with the pressurized oil chamber of the hydraulic power source through the cylinder body.

In some embodiments, the hydraulic power source for the locking hydraulic cylinder is a plunger hydraulic cylinder. A plunger of the hydraulic power source is connected to the movable beam so that the plunger moves together with the movable beam. Also, a built-in through-flow hole is provided within the plunger. A first end of the built-in through-flow hole is in communication with the second end of the connecting pipe, whereas a second end of the built-in through-flow hole is in communication with the pressurized oil chamber of the hydraulic power source.

In some embodiments, the hydraulic power source for the locking hydraulic cylinder is a piston hydraulic cylinder. A piston rod of the hydraulic power source is connected to the movable beam so that the piston rod moves with the movable beam. A built-in through-flow hole is provided within the piston rod. A first end of the built-in through-flow hole is in communication with the second end of the connecting pipe, whereas a second end of the built-in through-flow hole is in communication with the pressurized oil chamber.

In some embodiments, the main hydraulic cylinder may serve as the hydraulic power source of the locking hydraulic cylinder. Specifically, the main hydraulic cylinder may be a plunger hydraulic cylinder, wherein a cylinder body of the main hydraulic cylinder is connected to the fixed beam, and a plunger of the main hydraulic cylinder is connected to the movable beam. A built-in through-flow hole is provided within the plunger. A first end of the built-in through-flow hole is in communication with the second end of the connecting pipe, and a second end of the built-in through-flow hole is in communication with a pressurized oil chamber of the main hydraulic cylinder.

In some embodiments, the return hydraulic cylinder may serve as the hydraulic power source of the locking hydraulic cylinder. Specifically, the return hydraulic cylinder may be a single piston rod hydraulic cylinder, wherein a cylinder body of the return hydraulic cylinder is connected to the fixed beam, and a piston rod of the return hydraulic cylinder is connected to the movable beam. A built-in through-flow hole is provided within the piston rod. A first end of the built-in through-flow hole is in communication with the second end of the connecting pipe, whereas a second end of the built-in through-flow hole is in communication with a rod chamber of the return hydraulic cylinder.

In some embodiments, the return hydraulic cylinder that serves as the hydraulic power source of the locking hydraulic cylinder may be a plunger hydraulic cylinder. A cylinder body of the return hydraulic cylinder is connected to the movable beam, and the second end of the connecting pipe is in communication with a pressurized oil chamber of the return hydraulic cylinder through the cylinder body of the return hydraulic cylinder. In an alternative embodiment, the plunger of the return hydraulic cylinder is connected to the movable beam, and a built-in through-flow hole is provided within the plunger. A first end of the built-in through-flow hole is in communication with the second end of the connecting pipe, whereas a second end of the built-in through-flow hole is in communication with a pressurized oil chamber of the return hydraulic cylinder.

The control valve is configured to connect or disconnect a hydraulic oil flowing between the pressurized oil chamber of the hydraulic power source and the locking hydraulic cylinder.

According to one aspect of the present disclosure, a method of replacing an upper anvil block of a hydraulic forging machine is provided. The hydraulic forging machine for implementing the method may be any of the implementations of a hydraulic forging machine according to the present disclosure. For example, the hydraulic forging machine may include a movable beam, an upper anvil block that is fixedly connected to the movable beam, a locking hydraulic cylinder that is fixedly connected to the movable beam, a connecting pipe that is fixedly connected to the movable beam, a control valve provided on the connecting pipe, a hydraulic power source for the locking hydraulic cylinder that is also fixedly connected to the movable beam, a main hydraulic cylinder, as well as a return hydraulic cylinder that is fixedly connected to the movable beam. Moreover, a first end of the connecting pipe is connected to the locking hydraulic cylinder, and a second end of the connecting pipe is connected to a pressurized oil chamber of the hydraulic power source. The return hydraulic cylinder serves as the hydraulic power source of the locking hydraulic cylinder. The locking hydraulic cylinder is configured to provide a locking-unlocking function between the upper anvil block and the movable beam, whereas the locking-unlocking function is realized by pressurized oil flowing between the locking hydraulic cylinder and the pressurized oil chamber of the hydraulic power source via the control valve and the connecting pipe. Also, a first end of the main hydraulic cylinder is connected to a fixed beam, and a second end of the main hydraulic cylinder is fixedly connected to the movable beam.

Specifically, the method of replacing an upper anvil block of a hydraulic forging machine may include the following steps: (a) a demounting step, which includes: placing an original upper anvil block on a lower anvil block, turning on the control valve to allow the pressurized oil to enter the pressurized oil chamber of the return hydraulic cylinder and subsequently the locking hydraulic cylinder via the connecting pipe and the control valve, unlocking the original upper anvil block from the movable beam as an oil pressure inside the locking hydraulic cylinder is increased, as well as separating the movable beam from the original upper anvil block by further increasing an oil pressure inside the pressurized oil chamber of the return hydraulic cylinder to raise the movable beam. (b) a mounting step, which includes: placing a new upper anvil block on the lower anvil block, aligning the new upper anvil block with the movable beam, supplying pressurized oil to the main hydraulic cylinder to lower the movable beam so that the movable beam engages with the new upper anvil block, as well as discharging the pressurized oil from the locking hydraulic cylinder to the pressurized oil chamber of the return hydraulic cylinder so that the locking hydraulic cylinder locks the new upper anvil block to the movable beam. (c) a final step, in which the control valve is turned off after the upper anvil block is replaced.

In comparison with existing techniques, the present disclosure provides an approach of using one or more of the hydraulic cylinders of the hydraulic forging machine that are connected to a movable beam as the hydraulic power source of the locking hydraulic circuit. This approach avoids having a hydraulic hose, or a drag chain of the hose, that connects between a movable beam of the hydraulic forging machine and a static machine frame of the hydraulic forging machine. This approach also provides an independent oil supply pipe that runs from the hydraulic system and the control valve to the machine frame. Consequently, a synchronous movement between the oil supply circuit of the locking device and the movable beam is realized, which not only simplifies the oil supply circuit of the locking device, but also improves the overall reliability of the hydraulic forging machine.

### BRIEF DESCRIPTION OF THE DRAWINGS

To illustrate the technical solutions of embodiments of the present disclosure more clearly, a brief introduction to the accompanying drawings required to describe the embodiments is given below. Obviously, the accompanying drawings in the description below are merely some embodiments of the present disclosure, based on which other drawings may also be obtained by a person of ordinary skill in the art without any inventive efforts. In the drawings:

FIG. 1 is a schematic structural diagram of a hydraulic forging machine according to a first embodiment of the present disclosure, wherein the hydraulic forging machine is in a locked state

FIG. 2 is a schematic structural diagram of the hydraulic forging machine of FIG. 1 in an unlocked state;

FIG. 3 is a schematic structural diagram of a hydraulic forging machine according to a second embodiment of the present disclosure, wherein the hydraulic forging machine is in an unlocked state;

FIG. 4 is a schematic structural diagram of a hydraulic forging machine according to a third embodiment of the present disclosure, wherein the hydraulic forging machine is in an unlocked state; and

FIG. 5 is a schematic structural diagram of a hydraulic forging that according to a fourth embodiment IV of the present disclosure, wherein the hydraulic forging machine is in a locked state.

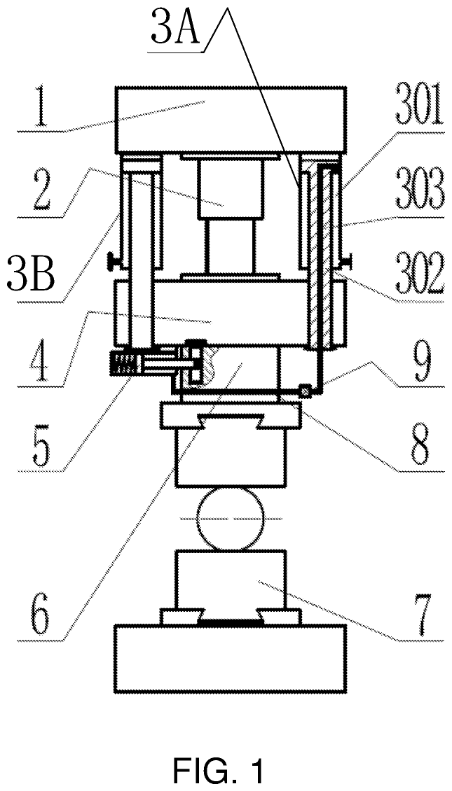

In FIGS. 1-5: 1 denotes a fixed beam, 2 denotes a main hydraulic cylinder, 201 denotes an oil inflow chamber of the main hydraulic cylinder 2, 202 denotes a piston rod of the main hydraulic cylinder 2, 203 denotes a built-in through-flow hole of the main hydraulic cylinder 2, each of 3A and 3B denotes a return hydraulic cylinder, 301 denotes an oil inflow chamber of the return hydraulic cylinder 3A, 302 denotes a piston rod of the return hydraulic cylinder 3A, 303 denotes a built-in through-flow hole of the return hydraulic cylinder 3A, 4 denotes a movable beam, 5 denotes a single piston rod locking hydraulic cylinder, 6 denotes an upper anvil block, 7 denotes a lower anvil block, 8 denotes a connecting pipe, and 9 denotes a control valve.

### DETAILED DESCRIPTION OF THE PREFERRED EMBODIMENTS

The detailed description of the present disclosure is presented largely in terms of procedures, steps, logic blocks, processing, or other symbolic representations that directly or indirectly resemble the operations of devices or systems contemplated in the present disclosure. These descriptions and representations are typically used by those skilled in the art to most effectively convey the substance of their work to others skilled in the art.

Reference herein to “one embodiment” or “an embodiment” means that a particular feature, structure, or characteristic described in connection with the embodiment can be comprised in at least one embodiment of the present disclosure. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams or the use of sequence numbers representing one or more embodiments of the present disclosure do not inherently indicate any particular order nor imply any limitations in the present disclosure.

To make the above objects, features and advantages of the present disclosure clearer and easier to understand, the present disclosure will be further described in detail below in connection with the accompanying drawings and particular implementations.

“One embodiment” or “embodiment” herein means a specific feature, structure or characteristic that may be included in at least one implementation of the present disclosure. “In one embodiment” throughout the specification refers to neither the same embodiment, nor a separate or optional embodiment contradictory to other embodiments. Unless especially stated, terms indicating a connection such as connected, linked and joined all refer to a direct or indirect connection.

The present disclosure is mainly intended to solve the problem of fixing and separating an upper anvil block to and from a movable beam. To fix and separate the upper anvil block to and from the movable beam, it is crucial to provide a locking hydraulic circuit for the upper anvil block. A hydraulic forging machine according to the present disclosure has an improved locking hydraulic circuit for an upper anvil block. The locking hydraulic circuit draws its hydraulic power from a pressurized oil chamber of a hydraulic cylinder connected to a movable beam, e.g., a pressurized oil chamber of a return hydraulic cylinder or a pressurized oil chamber of a main hydraulic cylinder. This not only ensures a synchronous movement between the locking hydraulic circuit and the movable beam, but also simplifies the design of the locking hydraulic circuit, which contributes to an improved reliability.

### First Embodiment

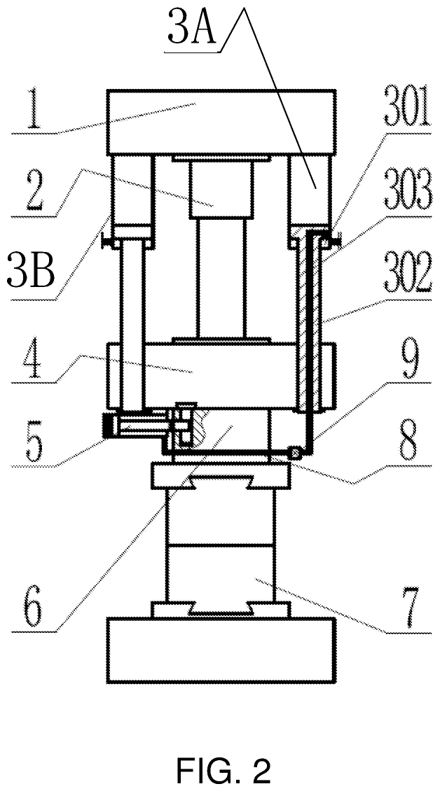

FIG. 1 illustrates a schematic structural diagram of a hydraulic forging machine according to a first embodiment of the present disclosure, wherein the hydraulic forging machine is in a locked state. FIG. 2 illustrates the hydraulic forging machine of FIG. 1 in an unlocked state.

As shown in FIGS. 1 and 2, the hydraulic forging machine of the first embodiment includes a fixed beam 1, a main hydraulic cylinder 2, a movable beam 4, a pair of return hydraulic cylinders 3A and 3B, an upper anvil block 6, and a locking hydraulic circuit for the upper anvil block (unlabeled). A cylinder body of the main hydraulic cylinder 2 is connected to the fixed beam 1. A plunger of the main hydraulic cylinder 2 is fixedly connected to an upper part of the movable beam 4. A lower end of the movable beam 4 is fixedly connected to the upper anvil block 6. Two ends of the fixed beam 1 are fixedly connected to cylinder bodies of the pair of return hydraulic cylinders 3A and 3B, respectively. Two ends of the movable beam 4 are fixedly connected to piston rods 302 of the pair of return hydraulic cylinders 3A and 3B, respectively.

In the embodiment shown in FIGS. 1 and 2, the locking hydraulic circuit for the upper anvil block includes a locking hydraulic cylinder 5, a connecting pipe 8, a control valve 9 provided on the connecting pipe 8, and a hydraulic cylinder that is fixedly connected to the movable beam 4 and can be used as a hydraulic power source of the locking hydraulic cylinder. One end of the connecting pipe 8 is connected to the locking hydraulic cylinder 5, and the other end of the connecting pipe 8 is connected to a pressurized oil chamber of the hydraulic cylinder that serves as the hydraulic power source of the locking hydraulic cylinder. Via the control valve 9 and the connecting pipe 8, pressurized oil may flow between the locking hydraulic cylinder 5 and the hydraulic cylinder that serves as the hydraulic power source of the locking hydraulic cylinder. In this embodiment, the hydraulic cylinder that serves as the hydraulic power source of the locking hydraulic cylinder is one of the return hydraulic cylinders 3A and 3B.

The return hydraulic cylinder 3A is a single piston rod return hydraulic cylinder. A cylinder body of the return hydraulic cylinder 3A is connected to the fixed beam 1, whereas a piston rod 302 of the return hydraulic cylinder 3A is connected to the movable beam 4. The locking hydraulic cylinder 5 is a one-way oil supply structure that includes a rod-less chamber and a rod chamber. The rod-less chamber has a reset spring provided therein, whereas an oil inlet-outlet is provided within the rod chamber. A cylinder body of the locking hydraulic cylinder 5 is fixed to the movable beam 4, and is able to move up and down together with the movable beam 4. The locking hydraulic cylinder 5 may extend or retract a piston rod thereof to lock or unlock the upper anvil block. That is, the upper anvil block can be locked to the movable beam and unlocked from the movable bean by a telescoping motion of the piston rod of the locking hydraulic cylinder 5.

A built-in through-flow hole 303 is provided within the piston rod 302 of the return hydraulic cylinder 3A. Specifically, for the embodiment shown in FIGS. 1 and 2, the built-in through-flow hole 303 that extends from an annular end face of a rod chamber of the piston rod to an end of the piston rod is provided within the piston rod 302 of the return hydraulic cylinder 3A. The built-in through-flow hole 303 has a shape of an upside-down or inverted “L”.

One end of the connecting pipe 8 is connected to the rod chamber of the locking hydraulic cylinder 5, whereas the other end of the connecting pipe 8 is connected to one end of the built-in through-flow hole 303. The other end of the built-in through-flow hole 303 is connected to an oil inflow chamber (or a pressurized oil chamber) 301 of the return hydraulic cylinder 3A. Namely, the connecting pipe 8 and the built-in through-flow hole 303 is sequentially connected between the oil inflow chamber 301 of the return hydraulic cylinder 3A and the rod chamber of the locking hydraulic cylinder 5, thereby forming the locking hydraulic circuit for the upper anvil block 6.

The connecting pipe 8 is fixedly connected to the movable beam 4 so that the connecting pipe 8 is able to move up and down together with the movable beam 4. The control valve 9 is provided on the connecting pipe 8 for controlling connection and disconnection of a hydraulic oil circuit between the oil inflow chamber 301 of the return hydraulic cylinder 3A and the locking hydraulic cylinder 5.

In order to lock the upper anvil block 6, the pressurized oil is discharged from the rod chamber of the locking hydraulic cylinder 5 to the oil inflow chamber 301 of the return hydraulic cylinder 3A via the connecting pipe 8 and the built-in through-flow hole 303 in the piston rod 302. The piston rod within the locking hydraulic cylinder 5 is thus able to extend out due to a spring force provided by the reset spring located within the rod-less chamber, thereby pushing a locking pin located at an end of the piston rod of the locking hydraulic cylinder 5 to lock the upper anvil block 6.

In order to unlock the upper anvil block 6, pressurized oil flows from the oil inflow chamber 301 of the return hydraulic cylinder 3A to the rod chamber of the locking hydraulic cylinder 5 via the built-in through-flow hole 303 in the piston rod 302 and the connecting pipe 8. The hydraulic pressure within the rod chamber of the locking hydraulic cylinder 5 thus imposes a force against the reset spring and push the piston rod within the locking hydraulic cylinder 5 to detach the locking pin from the upper anvil block 6.

For the purpose of understanding the present disclosure, a process is introduced in detail below regarding replacing the upper anvil block 6 of the hydraulic forging machine of in FIGS. 1 and 2.

a. Demounting: As shown in FIG. 2, the upper anvil block 6 is placed on a lower anvil block 7. The control valve 9 is turned on. An operator turns an operating handle of the hydraulic forging machine to a slow return position. The pressurized oil enters the oil inflow chamber 301 of the return hydraulic cylinder 3A and then enters the rod chamber of the locking hydraulic cylinder 5 via the built-in through-flow hole 303, the connecting pipe 8, and the control valve 9. An increased oil pressure in the rod chamber of the locking hydraulic cylinder 5 causes the piston rod of the locking hydraulic cylinder 5 to retract. The locking pin is thus pulled back and unlock the original upper anvil block 6. As the oil pressure within the oil inflow chamber 301 of the return hydraulic cylinder 3A further increases, the piston rod 302 of the return hydraulic cylinder 3A moves up to drive the movable beam 4 to move upward, so that the movable beam is detached from the original upper anvil block 6. The original upper anvil block 6 becomes free and may be moved away from the lower anvil block 7.

b. Mounting: As shown in FIG. 1, a new upper anvil block 6 is placed on the lower anvil block 7 and is aligned with the movable beam 4. An operator turns the operating handle of the hydraulic forging machine to supply pressurized oil to the main hydraulic cylinder 2, such that the plunger of the main hydraulic cylinder 2 moves down and drives the movable beam 4 to be engaged properly with the new upper anvil block 6. The oil inside the oil inflow chamber 301 of the return hydraulic cylinder 3A is discharged to an oil tank, and at the same time the oil inside the rod chamber of the locking hydraulic cylinder 5 returns to the oil inflow chamber 301 of the return hydraulic cylinder 3A. The piston rod of the locking hydraulic cylinder 5 is thus driven by the reset spring to extend and push the locking pin outwards to lock the new upper anvil block 6.

c. The control valve 9 is turned off after the upper anvil block is replaced, and the hydraulic forging machine is ready for normal operation.

### Second Embodiment

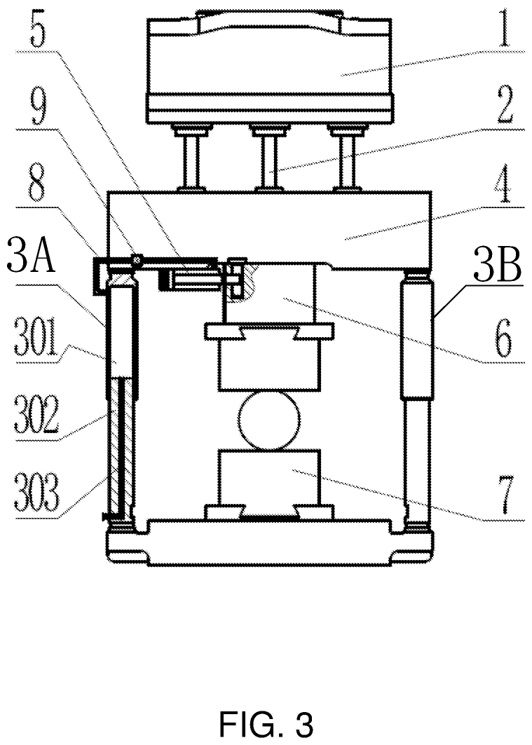

FIG. 3 is a schematic structural diagram of a hydraulic forging machine according to a second embodiment of the present disclosure, wherein the hydraulic forging machine is in an unlocked state.

The locking hydraulic circuit of FIG. 3 for locking and unlocking an upper anvil block thereof is identical to the locking hydraulic circuit of FIGS. 1 and 2 except for the following: The Each of the return hydraulic cylinders 3A and 3B of FIG. 3 is a plunger cylinder; a cylinder body of the plunger return hydraulic cylinder 3A is connected to the movable beam 4, and the cylinder body of the return hydraulic cylinder 3A moves together with the movable beam 4; one end of the connecting pipe 8 is connected to the rod chamber of the locking hydraulic cylinder 5, and the other end of the connecting pipe 8 is connected to the oil inflow chamber (or a pressurized oil chamber) 301 of the return hydraulic cylinder 3A through the cylinder body of the return hydraulic cylinder 3A; pressurized oil for the locking hydraulic cylinder 5 is directly introduced from the cylinder body of the return hydraulic cylinder 3A to the locking hydraulic cylinder 5.

### Third Embodiment

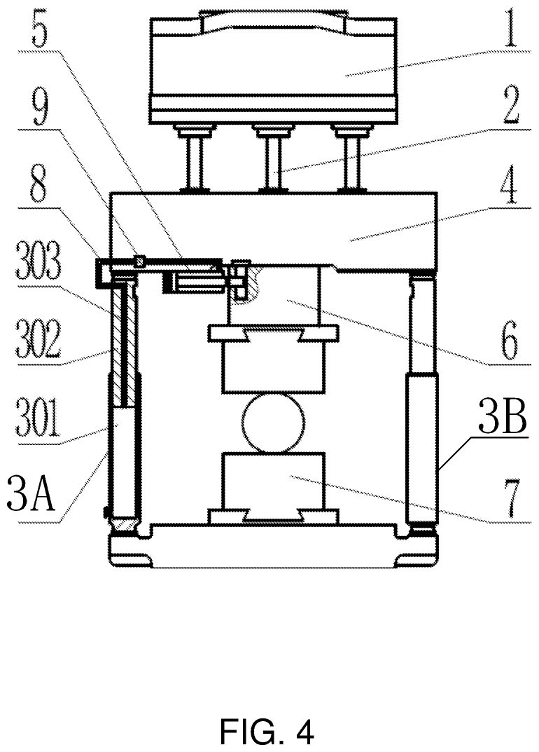

FIG. 4 is a schematic structural diagram of a hydraulic forging machine according to a third embodiment of the present disclosure, wherein the hydraulic forging machine is in an unlocked state.

The locking hydraulic circuit of FIG. 4 for locking and unlocking an upper anvil block thereof is identical to the locking hydraulic circuit of FIGS. 1 and 2 except for the following: Each of the return hydraulic cylinders 3A and 3B in FIG. 4 is a plunger cylinder; a plunger of the plunger return hydraulic cylinder 3A is connected to the movable beam 4, and the plunger of the plunger return hydraulic cylinder 3A moves together with the movable beam 4; the built-in through-flow hole 303 is provided within the plunger of the plunger return hydraulic cylinder 3A, one end of the built-in through-flow hole 303 is connected to the other end of the connecting pipe 8, and the other end of the built-in through-flow hole 303 is in communication with an oil inflow chamber 301 of the plunger return hydraulic cylinder 3A; pressurized oil for the locking hydraulic cylinder 5 is introduced from the plunger of the plunger return hydraulic cylinder 3A to the locking hydraulic cylinder 5.

### Fourth Embodiment

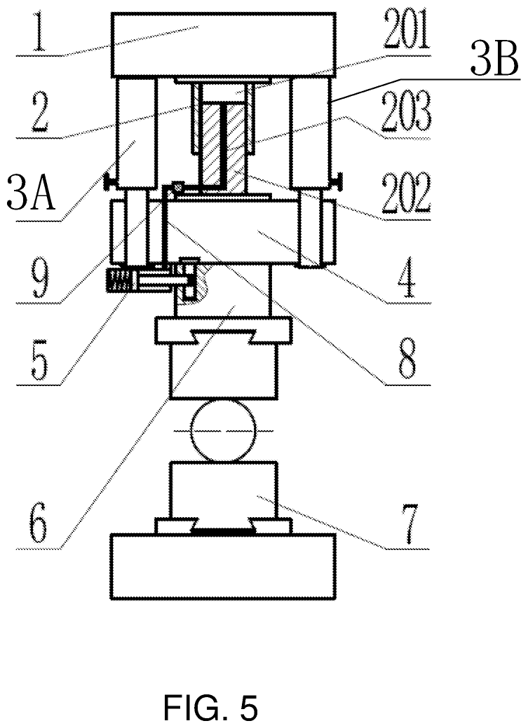

FIG. 5 is a schematic structural diagram of a hydraulic forging machine according to a fourth embodiment of the present disclosure, wherein the hydraulic forging machine is in a locked state.

The locking hydraulic circuit of FIG. 5 for locking and unlocking an upper anvil block thereof is identical to the locking hydraulic circuit of FIGS. 1 and 2 except for the following: the main hydraulic cylinder 2 serves as the hydraulic power source of the locking hydraulic cylinder. In the fourth embodiment, the main hydraulic cylinder 2 is a plunger hydraulic cylinder. A cylinder body of the main hydraulic cylinder 2 is connected to the fixed beam 1 of the hydraulic forging machine, and a plunger of the main hydraulic cylinder 2 is connected to a movable beam 4. A built-in through-flow hole 203 is provided within the plunger of the main hydraulic cylinder. One end of the built-in through-flow hole 203 is connected to the other end of a connecting pipe 8, and the other end of the built-in through-flow hole 203 is connected to a oil inflow chamber (or a pressurized oil chamber) 201 of the main hydraulic cylinder 2. The locking and unlocking of the upper anvil block 6 by the locking hydraulic cylinder 5 operates in a similar way as that in each of the embodiments above, and the relevant details are not repeated herein.

In summary, the present disclosure provides various embodiments of a locking hydraulic circuit for locking and unlocking an upper anvil block of a hydraulic forging machine, wherein the locking hydraulic circuit employs one or more of the hydraulic cylinders of the hydraulic forging machine that are connected to a movable beam (e.g., a return hydraulic cylinder and/or a main hydraulic cylinder) as the hydraulic power source of the locking hydraulic circuit. This approach avoids having a hydraulic hose, or a drag chain of the hose, that connects between a movable beam of the hydraulic forging machine and a static machine frame of the hydraulic forging machine. This approach also provides an independent oil supply pipe that runs from the hydraulic system and the control valve to the machine frame. Consequently, a synchronous movement between the oil supply circuit of the locking device and the movable beam is realized, which not only simplifies the oil supply circuit of the locking device, but also improves the overall reliability of the hydraulic forging machine.

In the present disclosure, terms indicating a connection such as “connected”, “joined”, “linked”, “coupled”, and “in communication with”, are used to refer to a direct or indirect connection.

It should be noted that any modification made by a person skilled in the art to a specific implementation of the present disclosure does not depart from the scope of the claims of the present disclosure. Accordingly, the scope of the claims of the present disclosure is not merely limited to the specific implementations mentioned above.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

1. A hydraulic forging machine, comprising:
a movable beam;
an upper anvil block being fixedly connected to the movable beam;
a locking hydraulic cylinder being fixedly connected to the movable beam;
a connecting pipe being fixedly connected to the movable beam;
a control valve provided on the connecting pipe; and
a hydraulic power source for the locking hydraulic cylinder, the hydraulic power source being fixedly connected to the movable beam,
wherein:
a first end of the connecting pipe is connected to the locking hydraulic cylinder,
a second end of the connecting pipe is connected to a pressurized oil chamber of the hydraulic power source,
the hydraulic power source comprises a main hydraulic cylinder or a return hydraulic cylinder,
the locking hydraulic cylinder is configured to provide a locking-unlocking function between the upper anvil block and the movable beam, and
the locking-unlocking function is realized by pressurized oil flowing between the locking hydraulic cylinder and the pressurized oil chamber of the hydraulic power source via the control valve and the connecting pipe.

2. The hydraulic forging machine of claim 1, further comprising:
the main hydraulic cylinder
wherein:
a first end of the main hydraulic cylinder is connected to a fixed beam, and
a second end of the main hydraulic cylinder is fixedly connected to the movable beam.

3. The hydraulic forging machine of claim 1, wherein:
the locking hydraulic cylinder comprises a single piston rod hydraulic cylinder,
a reset spring is provided in a rod-less chamber of the locking hydraulic cylinder,
an oil inlet-outlet is provided within a rod chamber of the locking hydraulic cylinder,
the oil inlet-outlet is connected to the first end of the connecting pipe, and
the upper anvil block is configured to be locked to the movable beam or unlocked from the movable bean by a telescoping motion of a piston rod of the locking hydraulic cylinder.

4. The hydraulic forging machine of claim 3, wherein:
the upper anvil block is configured to be locked by a combination of the following:
the pressurized oil being discharged from the rod chamber of the locking hydraulic cylinder to the pressurized oil chamber of the hydraulic power source via the connecting pipe; and
the piston rod within the locking hydraulic cylinder extending out due to a spring force provided by the reset spring to lock the upper anvil block, and the upper anvil block is configured to be unlocked by a combination of the following:
the pressurized oil flowing from the pressurized oil chamber of the hydraulic power source to the rod chamber of the locking hydraulic cylinder via the connecting pipe; and
a hydraulic pressure within the rod chamber of the locking hydraulic cylinder imposing a force against the reset spring to retract the piston rod within the locking hydraulic cylinder and unlock the upper anvil block.

5. The hydraulic forging machine of claim 1, wherein:
a cylinder body of the hydraulic power source is connected to the movable beam so that the cylinder body moves together with the movable beam, and
the second end of the connecting pipe is in communication with the pressurized oil chamber of the hydraulic power source through the cylinder body.

6. The hydraulic forging machine of claim 1, wherein:
the hydraulic power source comprises a plunger hydraulic cylinder,
a plunger of the hydraulic power source is connected to the movable beam so that the plunger moves together with the movable beam,
a built-in through-flow hole is provided within the plunger,
a first end of the built-in through-flow hole is in communication with the second end of the connecting pipe, and
a second end of the built-in through-flow hole is in communication with the pressurized oil chamber of the hydraulic power source.

7. The hydraulic forging machine of claim 1, wherein:
the hydraulic power source comprises a piston hydraulic cylinder,
a piston rod of the hydraulic power source is connected to the movable beam so that the piston rod moves with the movable beam,
a built-in through-flow hole is provided within the piston rod,
a first end of the built-in through-flow hole is in communication with the second end of the connecting pipe, and
a second end of the built-in through-flow hole is in communication with the pressurized oil chamber.

8. The hydraulic forging machine of claim 2, wherein:
the main hydraulic cylinder serves as the hydraulic power source of the locking hydraulic cylinder,
the main hydraulic cylinder comprises a plunger hydraulic cylinder,
a cylinder body of the main hydraulic cylinder is connected to the fixed beam,
a plunger of the main hydraulic cylinder is connected to the movable beam,
a built-in through-flow hole is provided within the plunger,
a first end of the built-in through-flow hole is in communication with the second end of the connecting pipe, and
a second end of the built-in through-flow hole is in communication with a pressurized oil chamber of the main hydraulic cylinder.

9. The hydraulic forging machine of claim 21, further comprising the main hydraulic cylinder and the return hydraulic cylinder, wherein:
a first end of the main hydraulic cylinder is connected to a fixed beam,
a second end of the main hydraulic cylinder is fixedly connected to the movable beam, and
the return hydraulic cylinder serves as the hydraulic power source of the locking hydraulic cylinder.

10. The hydraulic forging machine of claim 9, wherein:
the return hydraulic cylinder comprises a single piston rod hydraulic cylinder,
a cylinder body of the return hydraulic cylinder is connected to the fixed beam,
a piston rod of the return hydraulic cylinder is connected to the movable beam,
a built-in through-flow hole is provided within the piston rod,
a first end of the built-in through-flow hole is in communication with the second end of the connecting pipe, and
a second end of the built-in through-flow hole is in communication with a rod chamber of the return hydraulic cylinder.

11. The hydraulic forging machine of claim 9, wherein:
the return hydraulic cylinder comprises a plunger hydraulic cylinder,
a cylinder body of the return hydraulic cylinder is connected to the movable beam,
the second end of the connecting pipe is in communication with a pressurized oil chamber of the return hydraulic cylinder through the cylinder body of the return hydraulic cylinder.

12. The hydraulic forging machine of claim 1, wherein:
the control valve is configured to connect or disconnect a hydraulic oil flowing between the pressurized oil chamber of the hydraulic power source and the locking hydraulic cylinder.

13. A method of replacing an upper anvil block of a hydraulic forging machine, the hydraulic forging machine comprising:
a movable beam;
an upper anvil block being fixedly connected to the movable beam;
a locking hydraulic cylinder being fixedly connected to the movable beam;
a connecting pipe being fixedly connected to the movable beam;
a control valve provided on the connecting pipe;
a hydraulic power source for the locking hydraulic cylinder, the hydraulic power source being fixedly connected to the movable beam;
a main hydraulic cylinder; and
a return hydraulic cylinder being fixedly connected to the movable beam,
wherein:
a first end of the connecting pipe is connected to the locking hydraulic cylinder,
a second end of the connecting pipe is connected to a pressurized oil chamber of the hydraulic power source,
the return hydraulic cylinder serves as the hydraulic power source of the locking hydraulic cylinder,
the locking hydraulic cylinder is configured to provide a locking-unlocking function between the upper anvil block and the movable beam,
the locking-unlocking function is realized by pressurized oil flowing between the locking hydraulic cylinder and the pressurized oil chamber of the hydraulic power source via the control valve and the connecting pipe,
a first end of the main hydraulic cylinder is connected to a fixed beam, and
a second end of the main hydraulic cylinder is fixedly connected to the movable beam, and
the method comprising:
a demounting step, comprising:
placing an original upper anvil block on a lower anvil block;
turning on the control valve to allow the pressurized oil to enter the pressurized oil chamber of the return hydraulic cylinder and subsequently the locking hydraulic cylinder via the connecting pipe and the control valve;
unlocking the original upper anvil block from the movable beam as an oil pressure inside the locking hydraulic cylinder is increased; and
separating the movable beam from the original upper anvil block by further increasing an oil pressure inside the pressurized oil chamber of the return hydraulic cylinder to raise the movable beam;
a mounting step, comprising:
placing a new upper anvil block on the lower anvil block;
aligning the new upper anvil block with the movable beam;
supplying pressurized oil to the main hydraulic cylinder to lower the movable beam so that the movable beam engages with the new upper anvil block; and
discharging the pressurized oil from the locking hydraulic cylinder to the pressurized oil chamber of the return hydraulic cylinder so that the locking hydraulic cylinder locks the new upper anvil block to the movable beam; and
a final step, comprising:
turning off the control valve after the upper anvil block is replaced.

14. The hydraulic forging machine of claim 9, wherein:
the return hydraulic cylinder comprises a plunger hydraulic cylinder,
a plunger of the return hydraulic cylinder is connected to the movable beam,
a built-in through-flow hole is provided within the plunger of the return hydraulic cylinder,
a first end of the built-in through-flow hole is in communication with the second end of the connecting pipe, and
a second end of the built-in through-flow hole is in communication with a pressurized oil chamber of the return hydraulic cylinder.
